(19) United States
(12) Patent Application Publication
(10) Pub. No.: US 2019/0185190 A1
(43) Pub. Date: Jun. 20, 2019

(54) PACKAGING DEVICE FOR ARTICLES AND METHOD FOR INSERTING ARTICLES INTO PREPARED OUTER PACKAGING

(71) Applicant: KRONES Aktiengesellschaft, Neutraubling (DE)

(72) Inventors: Wolfgang FECHTER, ROSENHEIM (DE); Christian CANALICCHIO, Bad Endorf (DE)

(21) Appl. No.: 16/111,401

(22) Filed: Aug. 24, 2018

(30) Foreign Application Priority Data
Sep. 1, 2017 (DE) 10 2017 120 133.5

(51) Int. Cl. B65B 35/36; B65B 21/18; B65B 21/06; B65G 15/28

(52) U.S. Cl. CPC B65B 35/36; B65B 21/18; B65G 2201/0244; B65G 15/28; B65B 21/06

(57) ABSTRACT

A packaging device (1) for articles, such as beverage containers and the like, is disclosed. The packaging device (1) comprises a transport device (12), at least one transfer device (4), which can receive a packaging means already unfolded into a cardboard box and/or outer packaging (7) and transfer it to the transport device (12), and at least one manipulator (30) designed for inserting articles into packaging means already unfolded into a cardboard box and/or outer packaging (7). It is provided that the at least one transfer device (4) can align packaging means already unfolded into a cardboard box and/or outer packaging (7) and thereby orientate them, which orientation is adapted to the respective insertion of articles (3) via the at least one manipulator (30).

### CLAIM OF PRIORITY

The present application claims priority to German Application DE 10 2017 120 133.5, filed on Sep. 1, 2017, which are incorporated by reference.

### FIELD OF THE INVENTION

This invention concerns a packaging device for articles and a process for inserting articles into packaging unfolded into cardboard boxes and/or into suitably prepared outer packaging.

### BACKGROUND OF THE INVENTION

The handling of articles often involves providing individual or multiple articles with an outer packaging. In the case of individual articles, this is done to improve their protection and/or to enhance their sales presentation. In the case of multiple articles, the outer packaging additionally creates a container consisting of several articles. Such containers represent an effective way of handling multiple articles simultaneously, for example of facilitating the concurrent transport of multiple articles. Containers consisting of multiple articles held together are therefore the most common sales unit type for many articles, such as beverage containers.

The articles are objects such as packaged or unpackaged objects, containers such as beverage bottles or cans. In turn, the articles themselves can be packages consisting of several objects, whereby the objects of a package can be held together, for example, by an enclosure surrounding a group of objects on their periphery, such as a strapping, an outer packaging, such as a wrapping, a shrink wrap or a carton or a carrying rack, such as a beverage crate, to name but a few conceivable designs.

Folding boxes, among others, are used as outer packaging for one or multiple articles, as they offer a high level of additional protection for the articles housed in them, if necessary; furthermore, they are stackable with the articles housed in them and also enable the articles they contain to be identified by information printed on or affixed to their outside. They may also serve as an advertising medium by displaying corresponding information on their exterior.

Folding boxes are industrially prefabricated, usually cuboid-shaped containers, folded or collapsed to a particularly small space or pack size, which folding boxes are transported and stored in a space-saving folded state until they are used so that, when needed, they can easily be unfolded by simple manual actions or mechanically into an outer packaging, as is known from folding boxes used as postal packages, for example. When folded, they take up little space for transport and storage.

Outer packaging formed by, for example, folding boxes may be designed with or without compartments, also known as baskets, arranged or arrangeable therein, separating and/or keeping individual articles away from each other.

Compartments are a so-called interior fitment which is to be arranged or is arranged in an outer packaging and which may, for example, consist of web inserted into one another and/or connected to one another, for instance, by bent edges and/or adhesive connections.

The webs can, for example, consist of cardboard and/or paperboard or plastics. For instance, corrugated cardboard can be used for the webs to protect sensitive articles. The webs are and/or are to be connected to each other by bent edges and/or adhesive connections and/or slots in the webs in such a way that the compartments provided for one or several articles are created with, for example, a rectangular, triangular or polygonal base in which articles are fixed to prevent them from slipping.

In summary, compartments assign fixed spaces to the articles within the outer packaging and thus protect them, for example, from colliding and rubbing against each other during further transport and/or storage of the outer packaging containing them until the articles are removed and consumed, which can otherwise result in a negative impression of quality due to abrasion marks on information applied to the articles, for example in the form of labels, and/or damage to the articles themselves.

Similar to the provision of folding boxes as outer packaging, compartments to be inserted into outer packaging are preferentially prefabricated and folded or collapsed to a particularly small space or pack size for transporting and storing in a space-saving folded state until they are used so that they can manually be unfolded by simple actions or mechanically when needed.

Compartments and/or outer packaging are preferably made of single-part or multi-part cartons made of stabilized paper types, such as cardboard and/or paperboard. Cartons in different thicknesses and sizes are available for all types of compartments and/or outer packaging. For sensitive articles, corrugated cardboard, for example, can be used to protect them.

Cardboard boxes which can be unfolded or pulled apart, folded or collapsed into compartments and/or outer packaging, which are hereinafter generally referred to as packaging means or packaging, have cardboard walls connected to each other by folded edges and/or adhesive connections and/or plug connections, which cardboard walls are, for example, cut and/or punched out of sheet material. When folded, at least two interconnected cardboard walls form an upper and a lower flat side respectively of a cardboard box folded flat.

For example, by pressing on the sides of a folded cardboard box and/or folded packaging of this kind, it can be unfolded into a compartment and/or outer packaging, referred to as unfolded packaging. It is also possible to hold the folded cardboard box on the respective surfaces of the upper and lower flat side of a cardboard box wall, for example by suction cups, and to increase the distance between the surfaces of the cardboard box walls, which distance is initially limited to the thickness of the folded cardboard box. With the cardboard box walls being connected to each other, the cardboard box walls arranged within the space spanned by the carton walls of the upper and lower flat side are also unfolded or pulled apart.

It is also possible to do the unfolding by a combination of applying lateral pressure and of pulling apart.

In the case of an outer packaging designed as a folding box, unfolding or pulling apart creates an interior space, and in the case of a foldable and unfoldable compartment or an outer packaging designed as a folding box already containing the compartment arranged, an interior space is created in each section of the compartment, which interior space respectively is accessible through an access opening spanning a plane normally extending to the cardboard walls, through which access opening articles can be introduced into the corresponding interior space.

After the respective compartment and/or the outer packaging containing the respective compartment has been pulled apart, the outer packaging together with the compartment is placed on a transport device, whereupon articles and/or beverage containers can be introduced into the chambers and/or interior spaces formed by the respective compartment. In order to prevent the outer packaging and the respective compartment from folding unintentionally and to ensure that the respective articles can be inserted with precision into the interior spaces and/or chambers formed by the respective compartment, aforementioned transport devices provided for the placement of a respective outer packaging have laterally adjacent guide rails. Between directly adjacent guide rails, a respective outer packaging can be arranged together with the accommodated compartment, wherein the respective lateral guide rails are in contact with the outer packaging, thereby holding the respective outer packaging with the respective compartment in its respective position and preventing an unintentional folding of the outer packaging and/or the respective compartment. Due to the position of the laterally adjacent guide rails, the position of the respective outer packaging and/or the respective compartment is at least largely predetermined, so that articles can be introduced specifically into the interior spaces and/or chambers formed by a respective compartment.

Transport devices which, due to the necessity described above, have to have adjacent side guide rails to date, have a complicated structure and are expensive to purchase. If a packaging device with such transport devices is to be set up, a great deal of time is also required, as the lateral guide rails must be installed and positioned with precision. In addition, such packaging devices require a lot of space.

### SUMMARY OF THE INVENTION

An aim of the invention can therefore be seen in providing an appropriate possibility for the packaging of articles, which is inexpensive to purchase and is characterized by a simple and clear structure and/or a simple implementation.

The above aim is achieved by the packaging device and the process comprising the characteristics of the independent claims. Additional advantageous arrangements are described in the dependent claims.

The invention concerns a packaging device for articles, such as beverage containers or the like. The packaging device comprises a transport device which can be used to move packaging already unfolded into a cardboard box and/or outer packaging as well as the articles and/or beverage containers inserted therein, towards a palletizing station. Thus, the transport device can be designed for the removal of packaging already unfolded into a cardboard box and/or outer packaging and the respective articles arranged therein and/or inserted therein.

The transport device can, for example, be designed as a horizontal conveyor. Thus, the transport device can comprise at least one circulating conveyor belt, on which packaging already unfolded into a cardboard box and/or outer packaging are placed, as described below.

Furthermore, the packaging device comprises at least one transfer device, which can receive a packaging already unfolded into a cardboard box and/or outer packaging and transfer it to the transport device. The at least one transfer device and/or a transfer tool formed as part of the at least one transfer device can thus receive packaging already unfolded into a cardboard box and/or outer packaging and then move them in the direction of the transport device, whereupon the respective packaging already unfolded into a cardboard box and/or outer packaging is placed on the transport device. The at least one transfer device may be designed for centering the packaging already unfolded into a cardboard box and/or outer packaging.

A component of the packaging device is also at least one manipulator designed for inserting articles into packaging already unfolded into a cardboard box and/or outer packaging. The manipulator can, for example, be designed as a handling unit or a gantry type system. Embodiments wherein the manipulator consists of a large number of gripper heads have proven suitable, whereby a respective gripper head can temporarily receive a respective article or a respective beverage container for insertion into a respective packaging already unfolded into a cardboard box and/or outer packaging.

An infeed can be supported, which provides several rows of articles intended for insertion into packaging already unfolded into a cardboard box and/or outer packaging. The infeed can also be designed as a horizontal conveyor and may comprise a circulating conveyor belt, on which the several rows of articles are provided. It is also conceivable that the several rows of articles arranged on the infeed are moved by back pressure. Several guide rails can be provided in the infeed area, which run parallel to each other. A row of articles respectively can be moved between two directly adjacent guide rails.

It is intended that by the at least one transfer device, packaging already unfolded into a cardboard box and/or outer packaging can be aligned and can thus be brought into an orientation adapted to the respective insertion of articles via the at least one manipulator. The at least one transfer device and the manipulator can thus work together, wherein the at least one transfer device brings packaging already unfolded into a cardboard box and/or outer packaging into an orientation which is adapted to the respective insertion of articles via the at least one manipulator wherein the at least one manipulator then inserts the articles into the respective oriented cardboard box and/or into the respective oriented outer packaging. If the outer packaging and/or cardboard box comprises compartments, articles and/or beverage containers can be inserted precisely into the respective compartments due to the known orientation of the respective outer packaging and/or the respective cardboard box. In addition, embodiments are conceivable wherein packaging already unfolded into an outer packaging and/or a cardboard box do not have such a compartment. Also for such designs, packaging already unfolded into an outer packaging and/or a cardboard box are aligned and brought into an orientation which is adapted to the respective insertion of articles via the at least one manipulator.

Since aligning and/or bringing into the orientation is effected by the at least one transfer device, the aforementioned transport device, which can remove packaging already unfolded into a cardboard box and/or outer packaging together with respective inserted articles, can be designed without railing and/or without corresponding guide rails. This allows the packaging device to be set up in a time-optimized manner. Since guide rails extending along the transport device are no longer necessary, the packaging device has a clear and simple design.

In particular, it is conceivable that the respective packaging already unfolded into a cardboard box and/or outer packaging, is continuously supported or held during the insertion of the respective articles and/or beverage containers. For example, at least one support arm described below may continuously support or hold the respective packaging unfolded into a cardboard box and/or outer packaging during the insertion of the respective articles or beverage containers. This ensures that the respective outer packaging or cardboard box does not fold unintentionally during the insertion of articles and/or beverage containers. After the respective articles and/or beverage containers have been inserted into the respective cardboard box and/or outer packaging, surface contact between the respective outer packaging and/or the respective cardboard box and the respective at least one support arm can be lifted. The articles and/or beverage containers inserted into the outer packaging and/or cardboard boxes then lend stability to the respective outer packaging and/or cardboard box and thereby prevent unintentional folding after insertion. For this reason, railings for stabilizing the outer packaging and/or cardboard box are not necessary in the area of the transport device.

Embodiments have proven suitable wherein the packaging device comprises an erecting device. The erecting device may be designed to form cardboard boxes and/or outer packaging by unfolding packaging and to transfer packaging already unfolded into a cardboard box and/or outer packaging to the at least one transfer device. It may be provided that the at least one transfer device or a transfer tool formed as part of the at least one transfer device can be moved back and forth between the transport device and the erecting device. In particular, the at least one transfer device may comprise a transfer tool in the form of an L-shaped form element, which can receive packaging already unfolded into a cardboard box and/or outer packaging from the erecting device and move it to the transport device. Thus, it is possible that the transfer tool designed as an L-shaped form element can be moved back and forth between the transport device and the erecting device.

Furthermore, a transfer tool designed as part of the at least one transfer device and/or possibly the transfer tool designed as an L-shaped form element may provide an orientation surface extending perpendicularly, on which perpendicularly extending orientation surface packaging already unfolded into a cardboard box and/or outer packaging can be aligned. In conceivable embodiments, the erecting device and the transfer tool or, where appropriate, the transfer tool designed as an L-shaped form element can cooperate so that the packaging unfolded into a cardboard box and/or outer packaging comes into contact with the orientation surface when it is received via the transfer tool or the transfer tool which may be designed as an L-shaped form element, and is thereby already aligned when being received.

The erecting device may, for example, comprise a pneumatic suction instrument, which receives a respective packaging, unfolds it into a respective outer packaging and/or cardboard box and then transfers it as packaging already unfolded into an outer packaging and/or cardboard box to the at least one transfer device and/or to the transfer tool respectively, which may be designed as an L-shaped form element. It is conceivable that the suction instrument brings the packaging unfolded into an outer packaging and/or cardboard box into flush contact with the orientation surface when it is handed over or received by the at least one transfer device and/or the transfer tool, which may be designed as an L-shaped form element. Immediately after the packaging already unfolded into an outer packaging and/or cardboard box has been placed on the transfer tool, which may be designed as an L-shaped form element, it is therefore possible that the respective packaging already unfolded into an outer packaging and/or cardboard box is already flush with the orientation surface.

Embodiments are also conceivable wherein the erecting device receives a respective packaging mechanically and clampingly, unfolds it into an outer packaging and/or cardboard box and then transfers it as packaging already unfolded into an outer packaging and/or cardboard box to the at least one transfer device and/or to the transfer tool, which may be designed as an L-shaped form element.

Also conceivable are embodiments wherein packaging already unfolded into a cardboard box and/or outer packaging are guided against the orientation surface with the aid of at least one support arm, possibly designed as part of the packaging device, and are thereby aligned and/or are thereby convertible into an orientation, which orientation is adapted to the respective insertion of articles via the at least one manipulator. In this case, the erecting device can place a packaging already unfolded into a cardboard box and/or outer packaging onto the transfer tool, whereupon the transfer tool is moved in the direction of the transport device together with the applied packaging already unfolded into a cardboard box and/or outer packaging. In this case, the packaging still carried by the transfer tool and already unfolded into an outer packaging and/or cardboard box can come into contact with the at least one support arm, wherein the at least one support arm pushes the packaging already unfolded into an outer packaging and/or cardboard box and still carried by the transfer tool against the orientation surface and brings it into flush contact with the orientation surface.

Thus, the packaging device may comprise at least one support arm cooperating with the transfer tool formed as part of the at least one transfer device such that an outer packaging received by the transfer tool can be pushed into flush contact with the orientation surface by a relative movement of the transfer tool with respect to the at least one support arm. It may be that the transfer tool formed as part of the at least one transfer device is an L-shaped form element or comprises an L-shaped form element, which L-shaped form element provides the perpendicular orientation surface.

For example, the L-shaped form element can consist of several segments that can be moved relative to each other. This means that the L-shaped form element can be adaptable to different dimensions and/or to a different number of outer packaging and/or cardboard boxes to be received.

Thus, the at least one transfer device can have an L-shaped form element for aligning and receiving packaging already unfolded into a cardboard box and/or outer packaging. As just mentioned, it is conceivable that the transfer tool is designed as an L-shaped form element for this purpose.

It may be provided that the packaging device comprises at least one first L-shaped form element which is prepared to receive and align first packaging already unfolded into a cardboard box and/or outer packaging. In addition, the packaging device can comprise at least one second L-shaped form element, which is prepared to receive and align second packaging already unfolded into a cardboard box and/or outer packaging. It may be provided that the dimensions of the first and second packaging already unfolded into a cardboard box and/or outer packaging differ from each other. Furthermore, the first L-shaped form element or the second L-shaped form element can optionally be used by the at least one transfer device for receiving and aligning the respective packaging already unfolded into a cardboard box and/or outer packaging. The first L-shaped form element and the second L-shaped form element can thus be detachable from the at least one transfer device. The packaging device and/or the at least one transfer device can thus be adapted easily and straightforwardly to different dimensions of packaging already unfolded into a cardboard box and/or outer packaging.

It may furthermore be provided that the at least one transfer device comprises at least one insertion aid. The at least one insertion aid can be designed to hold and/or support the respective packaging already unfolded into a cardboard box and/or outer packaging during the insertion of respective articles. It is conceivable here that the at least one insertion aid has at least one projection and/or at least one finger, which respective at least one projection and/or at least one finger can hold or support the respective packaging already unfolded into a respective outer packaging in its respective position by immersing it in a chamber formed via a compartment of a packaging already unfolded into an outer packaging. In addition, a counter-holder may be provided, possibly as part of the at least one insertion aid, which can be brought into contact with the respective packaging already unfolded into a cardboard box and/or outer packaging by applying force in order to hold and/or support the respective packaging already unfolded into a cardboard box and/or outer packaging.

It is also possible that the at least one insertion aid provides a guide, preferably in the form of a frame, for articles to be inserted into the respective cardboard box and/or outer packaging formed by an already unfolded packaging. The guide, preferably designed as a frame, can thus be positioned above the respective packaging already unfolded into a cardboard box and/or outer packaging, whereupon the respective articles or beverage containers are inserted via the manipulator into the respective packaging already unfolded into a cardboard box and/or outer packaging and pass by the guide preferably designed as a frame or pass through the guide preferably designed as a frame.

It is also conceivable that the guide preferably formed as a frame can be placed onto packaging unfolded into an outer packaging and/or cardboard box by applying force so that the respective packaging already unfolded into an outer packaging and/or cardboard box is held via the guide, which is placed by applying force and which is preferably designed as a frame.

The packaging device may also comprise at least one support arm, which at least one support arm is formed to support a respective outer packaging and/or cardboard box formed by unfolding a packaging during the insertion of respective articles. As mentioned above, the at least one transfer device and/or a transfer tool of the at least one transfer device can provide a perpendicularly extending orientation area. It may be that the at least one support arm and the transfer tool work together to move a respective packaging received via the transfer tool and already unfolded into an outer packaging and/or cardboard box against the perpendicularly extending orientation area. For example, the at least one support arm may be fixed wherein the transfer tool moves the received packaging already unfolded into an outer packaging and/or cardboard box against the at least one support arm so that the packaging already unfolded into an outer packaging and/or cardboard box is hereby pushed by the at least one support arm and comes into contact with the perpendicularly extending orientation surface.

Also embodiments have proven suitable wherein the at least one support arm is carried hanging and pointing downwards by the at least one insertion aid. The guide preferably designed as a frame and the at least one support arm can therefore be mechanically coupled to each other. In conceivable embodiments, it may be provided that the at least one support arm can be selectively attached to the guide preferably designed as a frame in several different positions which are offset from one another in a vertical direction.

The invention also concerns a process for the insertion of articles, such as beverage containers or the like, into packaging unfolded into cardboard boxes and/or outer packaging. Features which have already been described above for various embodiments of the packaging device may also be provided for various embodiments of the process described below and are not mentioned redundantly. In addition, the features described below, which relate to various embodiments of the process, may be provided for the previously described packaging device. It is conceivable that the packaging device is designed or prepared for the implementation of the process described below.

As part of one step of the process, a packaging already unfolded into a cardboard box and/or outer packaging is received via at least one transfer device and then transferred to a transport device by the at least one transfer device.

Furthermore, at least one article is inserted into a respective packaging already unfolded into a cardboard box and/or outer packaging, and the packaging, which is already unfolded into a cardboard box and/or outer packaging and transferred to the transport device, is transported away via the transport device, together with the respective at least one article inserted.

It is provided that the packaging already unfolded into a cardboard box and/or outer packaging is aligned via the at least one transfer device and thereby attains an orientation which is adapted to the insertion of the at least one article into the respective packaging already unfolded into a cardboard box and/or outer packaging.

Furthermore, it can be provided that an erecting device unfolds a packaging and thereby forms a cardboard box and/or outer packaging from the packaging. A variety of packaging can be provided in stacked form, whereby the erecting device removes a respective packaging arranged at the top of the stack from the stack and unfolds it, thereby forming a cardboard box and/or outer packaging from the respective packaging.

Furthermore, the at least one transfer device and/or a transfer tool formed as part of the at least one transfer device can be moved back and forth between the transport device and the erecting device for receiving a respective packaging already unfolded into a cardboard box and/or outer packaging and for transferring the at least one received packaging already unfolded into a cardboard box and/or outer packaging to the transport device.

It may also be that the at least one transfer device and/or a transfer tool formed as part of the at least one transfer device provides a perpendicularly extending orientation surface, with which perpendicularly extending orientation surface a packaging already unfolded into a cardboard box and/or outer packaging is brought into contact and, as a result, into the orientation adapted to the insertion of the at least one article into the respective packaging already unfolded into a cardboard box and/or outer packaging.

Embodiments have proven suitable wherein the respective packaging already unfolded into a cardboard box and/or outer packaging is placed in contact and/or flush contact already at the time of receipt via the at least one transfer device and/or the transfer tool with the orientation surface running vertically. Alternatively or in addition, it can be that the packaging already unfolded into a cardboard box and/or outer packaging comes into contact with at least one support arm located in the region of the transport device, which places and/or pushes the packaging already unfolded into a cardboard box and/or outer packaging against the perpendicularly extending orientation surface into flush contact. In particular, the at least one support arm located in the region of the transport device can push the packaging already unfolded into a cardboard box and/or outer packaging against the perpendicularly extending orientation surface so that the packaging already unfolded into a cardboard box and/or outer packaging thus comes into flush contact with the orientation surface.

It is also conceivable that the at least one support arm located in the region of the transport device maintains its contact with the respective packaging already unfolded into a cardboard box and/or outer packaging during the respective insertion of articles.

It is conceivable that the transfer device may include at least one insertion aid. Here, the at least one insertion aid can temporarily hold and/or support a respective packaging already unfolded into a cardboard box and/or outer packaging during the insertion of respective articles. It is also possible that the at least one insertion aid provides a guide for articles, preferably in the form of a frame, through which guide preferably formed as a frame, articles are moved during insertion into the respective cardboard box formed by an unfolded packaging and/or during insertion into the respective outer packaging formed by an unfolded packaging.

Embodiments have proven suitable in which the at least one insertion aid formed as part of the at least one transfer device holds a packaging already unfolded into a cardboard box and/or outer packaging in the region of the transport device, whereupon a transfer tool of the at least one transfer device carrying up to that point the packaging already unfolded into a cardboard box and/or outer packaging is moved away from the transport device so that the packaging already unfolded into a cardboard box and/or outer packaging loses its contact with the transfer tool and is placed on the transport device.

It is possible in this case that the movement of the transfer tool away from the transport device starts before and/or during the insertion of articles into the packaging held in the region of the transport device and already unfolded into a cardboard box and/or outer packaging.

### BRIEF DESCRIPTION OF THE FIGURES

In the following, embodiments will explain the invention and its advantages in more detail using the attached figures. The proportions of the individual elements to each other in the figures do not always correspond to the real proportions since some shapes are simplified and others are enlarged in relation to other elements for better illustration.

FIG. 1 shows a schematic view of an embodiment of a packaging device and clearly shows a step as it can be provided for various embodiments of the inventive process.

FIGS. 2 to 7 each show the embodiment of a packaging device from FIG. 1 and illustrate further steps that can be provided for the embodiments of the inventive process.

FIGS. 8 to 11 each show a schematic view of an embodiment of an inventive packaging device.

Identical reference signs are used for identical or identically acting elements. In addition, for the sake of clarity, the only reference signs shown in the individual figures are those which are necessary for the description of the respective figure. The embodiments shown are only examples of how the invention can be designed and do not represent a final limitation. It should also be noted that all of the features described below are not closely linked to other features of the respective embodiment. Rather, all of the features described below can be provided individually and detached from the respective embodiment and/or in a general context.

### DETAILED DESCRIPTION OF THE INVENTION

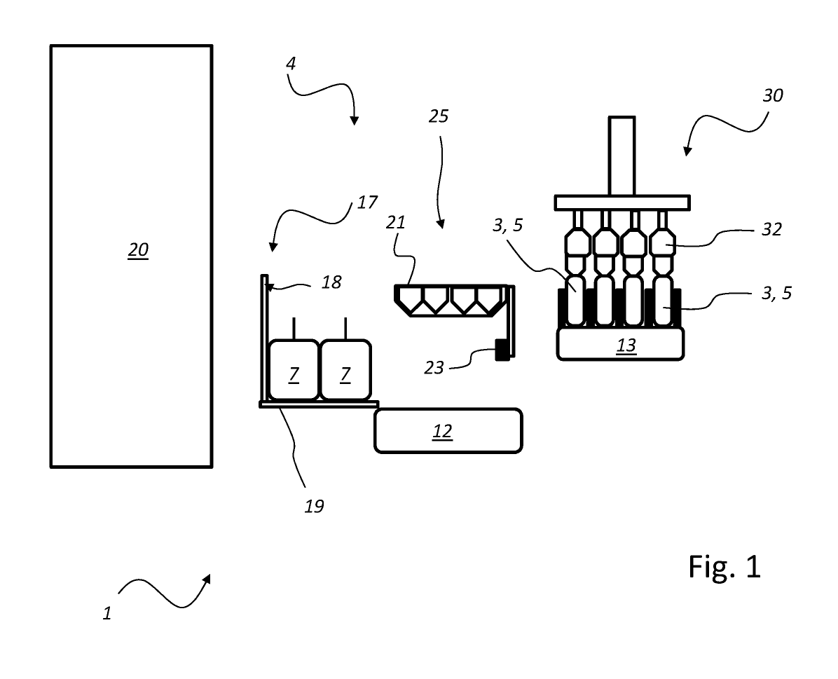

The schematic view of FIG. 1 shows an embodiment of a packaging device 1. By the packaging device 1, articles 3, which are formed as beverage containers 5, can be inserted into outer packaging 7.

The packaging device 1 from the embodiment in FIG. 1 comprises a transport device 12. As described below, the transport device 12 can transport outer packaging 7 and respective articles 3 inserted into the outer packaging 7 in the direction of the image plane. The schematic view of FIG. 1 already shows that no guide rails are provided in the region of the transport device 12 in order to support the respective outer packaging 7 during the insertion of articles 3 and/or beverage containers 5 and to guide them towards the image plane during a movement of the outer packaging 7 and the articles 3 inserted therein and formed by beverage containers 5. The transport device shown under reference number 12 is designed as a horizontal conveyor and comprises a circulating conveyor belt, on which the outer packaging 7 stand and by which circulating conveyor belt the outer packaging 7 and the articles 3 and/or beverage containers 5 inserted therein can be moved in the direction of the image plane.

Furthermore, an infeed 13 designed as part of the packaging device 1 is shown, which provides articles 3 and/or beverage containers 5 for insertion into outer packaging 7 and conveys or transports them to this end in the opposite direction of the image plane. A conveying direction of the transport device 12 and a conveying direction of the infeed 13 are thus oriented parallel to each other and run opposite to one another. Via the infeed 13, several rows of articles 3 and/or beverage containers 5 are provided.

The erecting device referred to as number 20, which is only schematically indicated at hand, is intended to unfold packaging and to form a respective outer packaging 7 from packaging by erecting them. In practice, the packaging not yet unfolded can be provided in horizontal form on a stack located in a working area of the erecting device 20, picked up by the erecting device 20, unfolded and removed from the stack. In the embodiment in FIG. 1, the outer packaging 7 comprises not recognizable compartments located inside the outer packaging 7 and forming a plurality of chambers. An article 3 and/or a beverage container 5 is inserted into a respective chamber formed by the compartment. The compartments can be unfolded and/or pulled apart together with the entire outer packaging 7 via the erecting device 20. A respective outer packaging 7 can thus hold several articles 3 and/or beverage containers 5.

Unfolded and as outer packaging 7, the packaging are then received by a transfer device 4. The transfer device 4 comprises a transfer tool 17 for receiving the packaging already unfolded and formed as outer packaging and/or a cardboard box. The transfer tool 17 can be moved back and forth between the erecting device 20 and the transport device 12 and is formed as an L-shaped form element 19 at hand.

FIG. 1 illustrates here that the transfer tool 17 is formed to receive several packaging already unfolded into an outer packaging 7 and/or that several packaging already unfolded into an outer packaging 7 can be received at the same time by the transfer tool 17 formed as part of the transfer device 4. The transfer tool 17 and/or the L-shaped form element 19 provides a horizontal surface to receive several outer packagings 7. Furthermore, the transfer tool 17 and/or the L-shaped form element 19 comprises an orientation surface, which is shown under reference number 18 and runs in perpendicular direction.

If a packaging already unfolded into an outer packaging 7 is received by the transfer tool 17 and/or the L-shaped form element 19, the respective outer packaging 7 can be placed on the transfer tool 17 via the erecting device 20 in such a way that the outer packaging 7 to be positioned in the area of the orientation area 18 gets in flush contact with the orientation surface 18 already at this point and is thereby aligned and brought into an orientation that is adapted to the respective subsequent insertion of articles 3 and/or beverage containers 5.

It is also conceivable that the erecting device 20 initially places packaging already unfolded into an outer packaging 7 onto the transfer tool 17 without an outer packaging lying flush against the orientation surface 18. As described below, the alignment can then be carried out at a later point in time using the support arm 23.

In addition, it is conceivable that the respective outer packaging is placed onto the transfer tool 17 via the erecting device 20 in such a manner that the outer packaging 7 to be positioned in the area of the orientation surface 18 already at this time is brought in flush contact with the orientation surface 18 and is thus aligned and be brought into an orientation which corresponds to the respective subsequent insertion of articles 3 and/or beverage containers 5. Since the respective outer packaging 7 received by the transfer tool 17 may inadvertently lose its flush contact with the orientation surface during a movement in the direction of the transport device 12, it may be provided that the support arm 23 again aligns the respective outer packaging flush on the orientation surface 18 and/or gets it in flush contact with the orientation surface 18.

The further outer packaging 7, which at the same time can be carried by the transfer tool 17 and/or the L-shaped forming element 19, is in surface contact with a lateral surface with the outer packaging 7, which outer packaging 7 rests against the orientation surface 18. If the aforementioned outer packaging 7 is already flush with the orientation surface 18, the further outer packaging 7 not in direct surface contact with the orientation surface 18 and carried by the transfer tool 17 is thus also aligned and brought into an orientation which is adapted to the respective subsequent insertion of articles 3 and/or beverage containers 5.

The packaging device 1 and/or the transfer device 4 also comprises an insertion aid 25 with a guide 21 provided for articles 3 and/or beverage containers 5, which guide 21 is designed as a frame in this case. Furthermore, a support arm 23 is part of the insertion aid 25. In the embodiment of FIG. 1, the guide 21 and the support arm 23 are mechanically coupled to each other. However, also embodiments are possible which lack such a mechanical coupling or where the packaging device 1 and/or the transfer device 4 only comprises a guide 21 or a support arm 23.

Furthermore, a manipulator 30 is provided, which can receive articles 3 and/or beverage containers 5 from the infeed 13 and can subsequently place and/or insert them in outer packaging 7. As described below, the manipulator 30 and the insertion aid 25 work together for the insertion of articles 3 and/or beverage containers 5 in outer packaging 7. In order to be able to receive articles 3 and/or beverage containers 5 from the infeed 13 temporally, the manipulator 30 comprises a plurality of gripper heads 32. In various embodiments, the gripper heads 32 can establish, for instance, a mechanical and/or pneumatic connection with the respective articles 3 and/or beverage containers 5 to temporally receive articles 3 and/or beverage containers 5.

It should also be noted that FIG. 1 may illustrate the manipulator 30 only partially. It is conceivable, for example, that a handling unit or a gantry type system is provided which is designed as part of the manipulator 30 and which can move back and forth the components of the manipulator 30 shown in FIG. 1 between the transport device 12 and the infeed 13. Likewise, the transfer tool 17 may comprise a handling unit not shown in the figures of this patent application and/or a gantry type system not shown in the figures of this patent application, by which handling unit and/or by which gantry type system the L-shaped form element comprising an orientation surface 18 for articles 3 and/or beverage containers 5 is carried and/or moved back and forth between the erecting device 20 and the transport device 12.

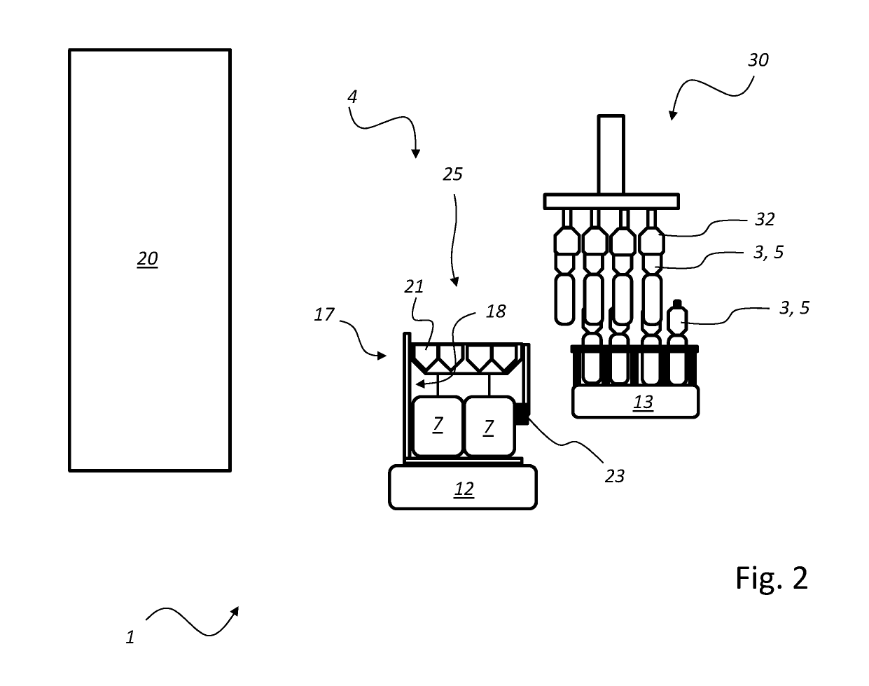

FIG. 2 shows again the embodiment of a packaging device from FIG. 1. A summary of FIGS. 1 and 2 illustrates a step as it may be provided with various embodiments of an inventive process.

Starting from FIG. 1, the transfer tool 17 and/or the L-shaped form element 19 was moved in the direction of the transport device whereas the transfer tool 17 and/or the L-shaped form element 19 has reached the transport device 12 in FIG. 2 and is arranged just above the transport device 12. The position of the insertion aid 25 in FIG. 2 is unchanged with respect to its position in FIG. 1. In addition, FIG. 2 shows that the outer packaging 7 not in direct surface contact with the orientation surface 18 of the transfer tool 17 and/or a lateral surface of the outer packaging 7 not in direct surface contact with the orientation surface 18 of the transfer tool 17 is brought in contact with the downwards pointing support arm 23 of the insertion aid 25 through the movement of the transfer tool 17. Through the movement of the transfer tool 17 in the direction of the support arm 23, the support arm 23 pushes the outer packaging 7 shown in FIG. 2 on the left side in flush contact against the orientation surface and/or aligns the outer packaging 7 shown in FIG. 2 on the left side in a flush manner and/or aligns the outer packaging 7 shown on the left side with the orientation area 18. As the outer packaging 7 shown in FIG. 2 on the left side is in flush contact with the orientation surface 18 and the further outer packaging 7 and/or the outer packaging 7 shown on the right side with an outer surface is in flush contact with an outer surface of the outer packaging 7, which is in contact with the orientation surface 18, both outer packaging 7 in FIG. 2 are brought into an orientation which is adapted to the subsequent insertion of articles 3 and/or beverage containers 5 via the manipulator 30.

The manipulator 30 already lifted several articles 3 and/or beverage containers 5 from the infeed 13 in FIG. 2 and moved them in the direction of the insertion aid 25, in the direction of the transfer tool 17 and in the direction of the transport device 12 for insertion into the outer packaging 7 carried and aligned by the transfer tool 17.

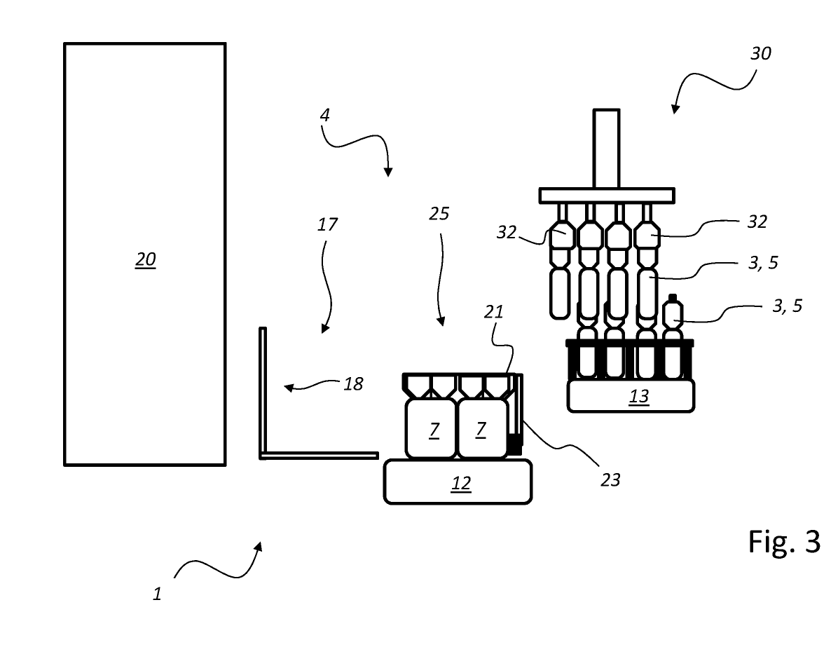

In FIG. 3, the embodiment of a packaging device 1 from FIGS. 1 and 2 is shown again. Furthermore, a summary of FIGS. 2 and 3 illustrates a step as it may be provided with various embodiments of an inventive process. The insertion aid 25 was lowered in the direction of the outer packaging 7 wherein the outer packaging 7 was held via the insertion aid 25 in the position from FIG. 3. It is possible that the insertion aid 25 has at least one projection and/or at least one finger not illustrated in the figures of this patent application, which respective at least one projection and/or at least one finger engages and/or is immersed in the at least one chamber formed by a compartment of the outer packaging 7 and thereby holds the respective outer packaging 7 in its position. It is also conceivable, for example, that a carrying handle formed as part of the outer packaging 7 and pointing upwards is gripped and/or seized by the insertion aid 25 and the respective outer packaging 7 thereby is held in its respective position by the insertion aid 25. In practice, there are more possibilities not described in full in the context of this patent application, by which the outer packaging 7 can be held via the insertion aid 25.

By holding the outer packaging 7 via the insertion aid 25, the transfer tool 17 and/or the L-shaped form element 19 can be moved back in the direction of the erecting device 20 in order to receive further packaging already unfolded into an outer packaging 7. Since the movement of the transfer tool 17 and/or the L-shaped form element 19 back towards the erecting device 20 already happens before articles 3 and/or beverage containers 5 are inserted into the outer packaging 7, a high throughput is achieved in the packaging of articles 3 and/or beverage containers 5 by the packaging device 1.

While the transfer tool 17 and/or the L-shaped form element 19 is moved in the direction of the erecting device 20, the outer packaging 7 is placed on the transport device 12 and/or loses contact with the transfer tool 17 and/or the L-shaped form element 19 and continues to be held via the insertion aid 25. Also, the support arm 23 formed here as part of the insertion aid 25 and pointing downwards continues to have surface contact with the lateral surface of the outer packaging 7.

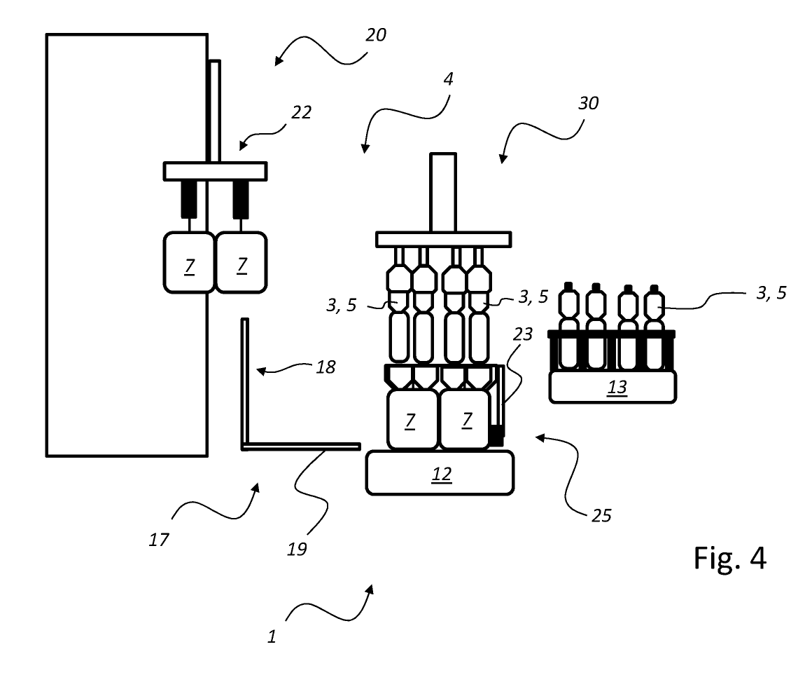

In FIG. 4, the embodiment of a packaging device 1 from FIGS. 1 to 3 is illustrated again. Also, a summary of FIGS. 3 and 4 illustrates a step as it may be provided with various embodiments of an inventive process.

As the transfer tool 17 and/or the L-shaped form element 19 has arrived at the erecting device 20 in FIG. 4, the erecting device 20 provides further outer packaging 7 for the transfer tool 17 formed as part of the transfer device 4 and/or the L-shaped form element. To this end, the erecting device 20 comprises a transport tool 22, which moves several packaging already unfolded into an outer packaging 7 in the direction of the transfer tool 17 and/or the L-shaped form element 19.

The position of the insertion aid 25 in FIG. 4 is unchanged with respect to its position in FIG. 3. The outer packaging 7 placed on the transport device 12 are further held in their position via the insertion aid 25. In FIG. 4, the manipulator 30 has achieved a position, in which the manipulator 30, solely by a vertical lowering movement, can insert the articles 3 and/or beverage containers 5 carried by the manipulator 30 into the outer packaging 7 placed on the transport device 12. Since the outer packaging 7 was brought into an orientation through alignment as previously described, which orientation is adapted to the subsequent insertion via the manipulator 30, the subsequent insertion can be carried out accurately and without problems. The insertion aid 25, which is still in contact with the outer packaging 7 now placed on the transport device 12, prevents unintentional folding by positioning the support arm 23 on the outer packaging and by holding the outer packaging in the described orientation. Guide rails, which support the outer packaging 7 already placed on the transport device 12 and thereby prevent unintentional folding, are therefore not necessary for the packing device 1.

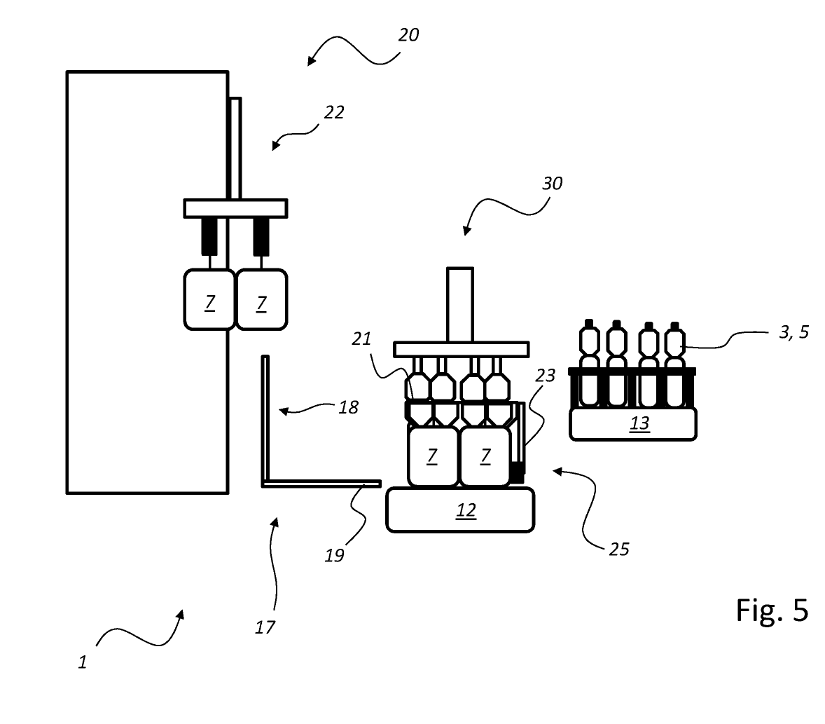

In FIG. 5, the embodiment of a packaging device 1 from FIGS. 1 to 4 is shown again. Furthermore, a summary of FIGS. 4 and 5 illustrates a step as it may be provided with various embodiments of an inventive process.

In FIG. 5, the manipulator 30 was lowered in the direction of the transport device 12, together with the articles 3 and/or beverage containers 5 carried by the manipulator 30. During lowering, the articles 3 and/or beverage containers 5 were moved through the guide 21 formed as part of the insertion aid 25 and/or the guide frame formed as part of the insertion aid 25. This ensures that the articles 3 and/or beverage containers 5 are guided accurately into their respective chambers formed by the compartment of the outer packaging 7.

During insertion, the outer packaging 7 placed on the transport device 12 continues to be held by the insertion aid 25. In addition, the support arm 23 formed as part of the insertion aid 25 continues to be in contact with a lateral surface of the outer packaging 7 pictured on the right side in FIG. 5 and already placed on the transport device 12.

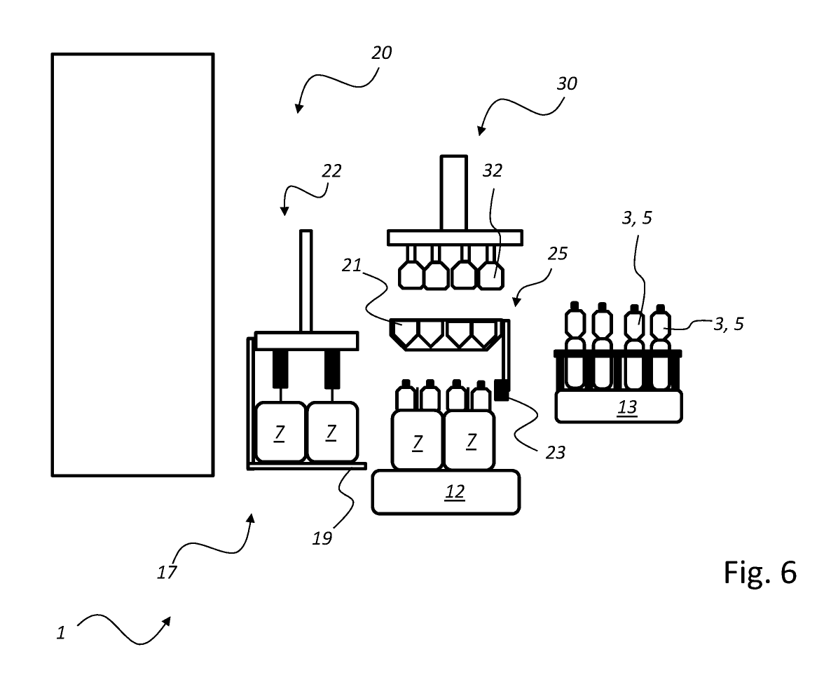

In FIG. 6, the embodiment of a packaging device 1 from FIGS. 1 to 5 is shown again. Furthermore, a summary of FIGS. 5 and 6 illustrates a step as it may be provided with various embodiments of an inventive process. In FIG. 6, the transport tool 22 of the erecting device 20 has now completely placed further packaging folded up into an outer packaging 7 on the transfer tool 17 wherein the outer packaging 7 pictured on the left side and carried by the transfer tool 17 is in flush contact with the orientation surface and is thereby aligned.

The manipulator 30 has inserted the articles 3 and/or beverage containers 5, which were still carried in FIG. 4, into the respective assigned outer packaging 7 and has been raised vertically in relation to the transport device 12. Also, the outer packaging 7 is no longer held via the insertion aid 25 wherein the insertion aid has been moved and/or raised vertically in relation to the transport device 12. There is no longer contact between the support arm 23 and a lateral surface of the outer packaging 7 placed on the transport device 12 and pictured on the right side, which still existed in FIG. 5. Furthermore, FIG. 6 shows that additional articles 3 and/or beverage containers 5 have already been provided via the infeed 13. The manipulator 30 therefore can be moved in the direction of the infeed 13 to receive additional articles 3 and/or beverage containers 5 provided for insertion into the outer packaging 7 carried by the transfer tool 17 in FIG. 6.

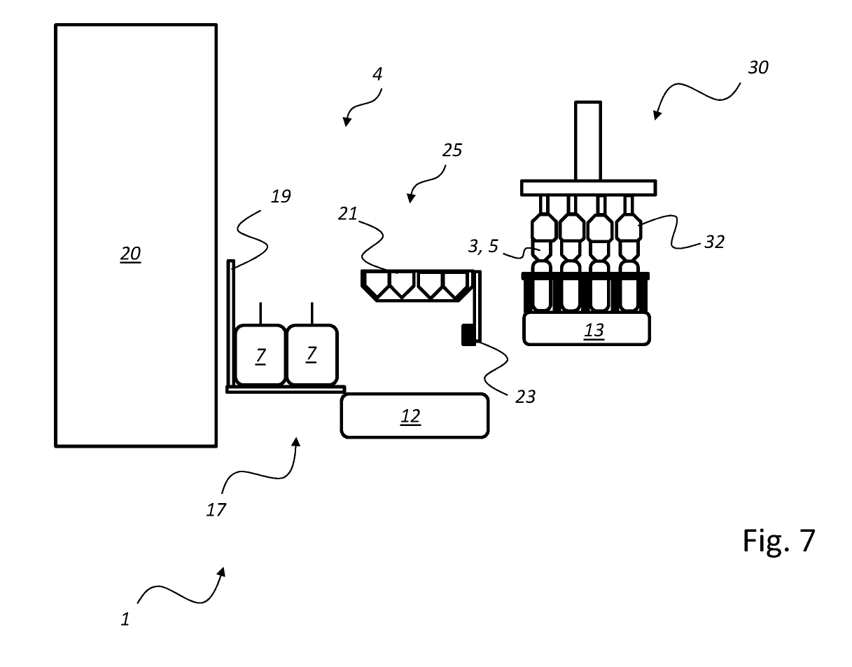

In FIG. 7, the embodiment of a packaging device 1 from FIGS. 1 to 6 is shown again. Furthermore, a summary of FIGS. 6 and 7 illustrates a step as it may be provided with various embodiments of an inventive process. The outer packaging 7 still pictured in FIG. 6 and placed on the transport device 12, into which the articles 3 and/or beverage containers 5 have been inserted, are no longer shown in FIG. 7 and have been transported via the transport device 12 in the direction of the image plane. For example, the outer packaging 7 with the inserted articles 3 and/or beverage containers 5 can be moved in the direction of a grouping station and/or palletizing station via the transport device 12.

In FIG. 7, the manipulator 30 is again in contact with articles 3 and/or beverage containers 5 via its gripper heads 32 as described in FIG. 1. The step according to FIG. 7 is followed by the steps described in FIGS. 2 to 6.

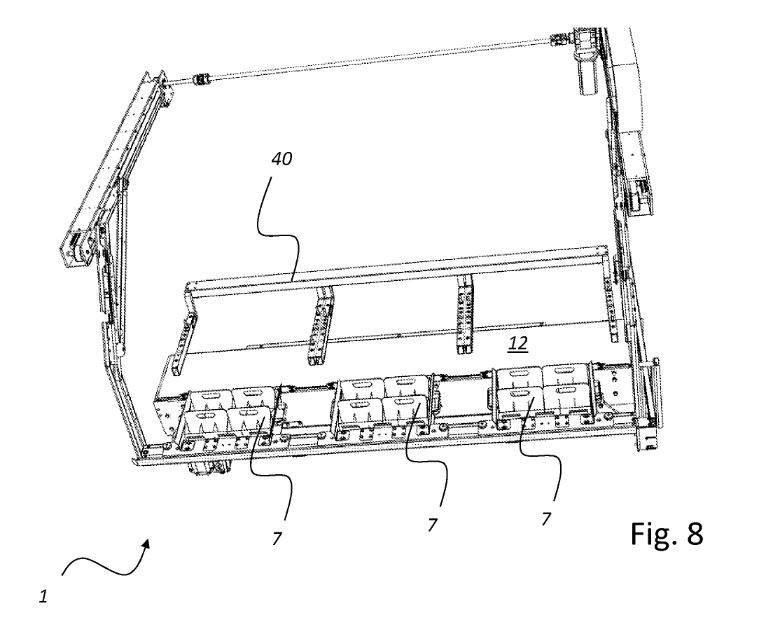

FIGS. 8 to 10 each show a schematic view of an embodiment of an inventive packaging device 1. It should be mentioned in advance that FIGS. 8 to 10 respectively do not show all the features of an embodiment of an inventive packaging device 1.

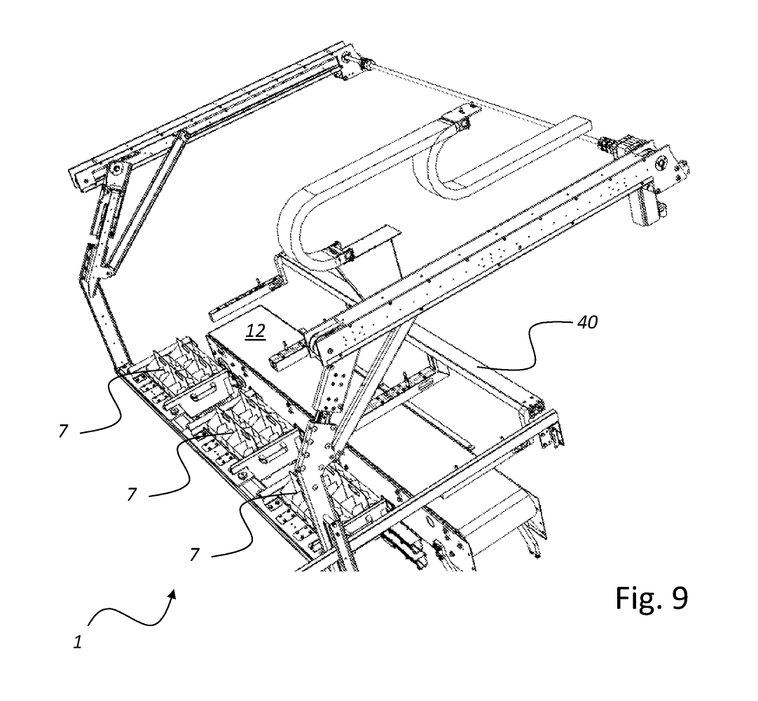

Thus, FIG. 8 shows again the transport device 12 already illustrated in FIGS. 1 to 7 as well as the packaging already unfolded to a respective outer packaging 7. Reference sign 40 refers to a suspension, to which the support arm 23 and/or the guide 21, preferably in the form of a frame (see FIGS. 1 to 7), can be attached. These components are shown again in FIG. 9, whereby FIG. 9 clearly illustrates that the transport device 12 comprises a circulating conveyor belt.

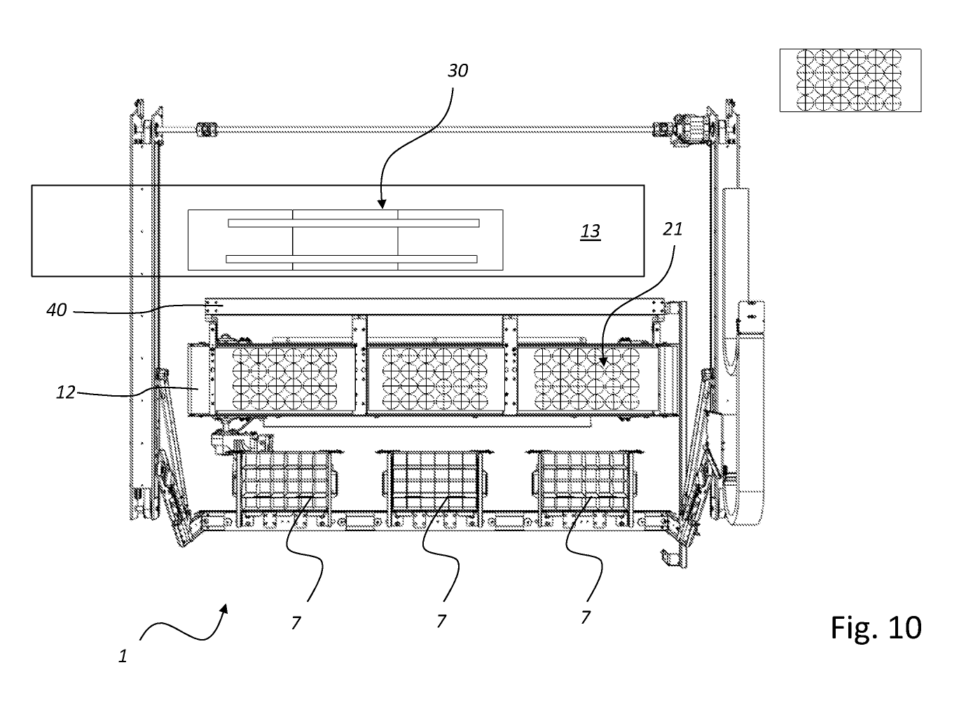

FIG. 10 shows a schematic plan view of an embodiment of a packaging device 1. According to FIGS. 8 and 9, the packaging already unfolded into an outer packaging 7 can also be seen in FIG. 10. In FIG. 10, the guide 21 and/or the guide frame also shown in FIGS. 1 to 7 is arranged on the suspension 40. Reference sign 13 continues to refer to an infeed for articles 3 and/or beverage containers 5 wherein the manipulator 30 is positioned above the infeed 13 to receive articles 3 and/or beverage containers 5.

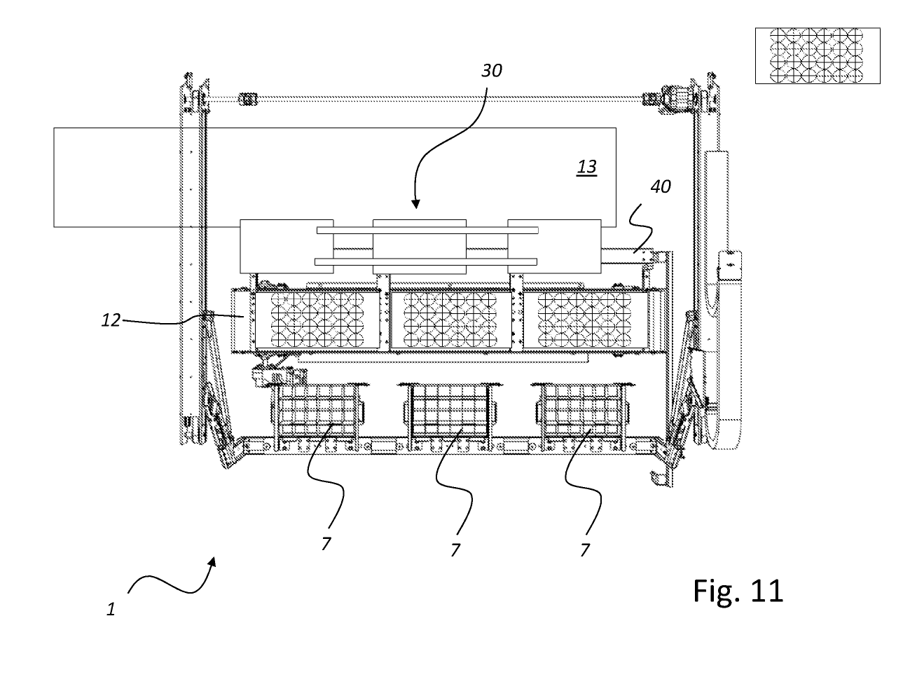

A summary of FIGS. 10 and 11 illustrates that the manipulator 30 is moved in the direction of the guide 21 to insert articles 3 and/or beverage containers 5 and hereby leaves the infeed 13. The subsequent insertion of articles 3 and/or beverage containers 5 in outer packaging 7 can be carried out subsequently to FIG. 11 in accordance with the previous description of FIGS. 4 to 7.

The invention was described with reference to a preferred embodiment. However, it is conceivable for an expert that variations or modifications of the invention can be made without leaving the scope of protection of the claims below.

### LIST OF REFERENCE SIGNS

1 Packaging device
2 Article
3 Transfer device
4 Beverage container
7 Outer packaging
12 Transport device
13 Infeed
17 Transfer tool
18 Orientation surface
19 L-shaped form element
20 Erecting device
21 Guide
22 Transport tool
23 Support arm
25 Insertion aid
30 Manipulator
32 Gripper head
40 Suspension

1. A packaging device (1) for articles (3), such as beverage containers (5) and the like, comprising:
a transport device (12),
at least one transfer device (4), which can receive a packaging already unfolded into a cardboard box and/or outer packaging (7) and transfer the unfolded packaging to the transport device (12), and
at least one manipulator (30) designed for inserting articles (3) into the unfolded packaging (7), wherein the at least one transfer device (4) aligns the unfolded packaging (7) to receive articles (3) via the at least one manipulator (30).

2. The packaging device of claim 1 comprising:
an erecting device (20) that forms cardboard boxes and/or outer packaging (7) by unfolding packaging and that transfers unfolded packaging (7) to the at least one transfer device (4),
wherein the at least one transfer device (4) and/or a transfer tool (17), as part of the at least one transfer device (4), can be moved back and forth between the transport device (12) and the erecting device (20).

3. The packaging device of claim 2 wherein the transfer tool (17) comprises a perpendicularly extending orientation surface (18), on which perpendicularly extending orientation surface (18), the unfolded packaging (7) can be aligned.

4. The packaging device of claim 3 further comprising at least one support arm (23), which interacts with the transfer tool (17), such that an unfolded outer packaging (7) received by the transfer tool (17) can be pushed into flush contact against the orientation surface (18) by a relative movement of the transfer tool (17) relative to the at least one support arm (23).

5. The packaging device of claim 4 wherein the at least one support arm (23) supports the unfolded packaging (7) during the insertion of articles (3).

6. The packaging device of claim 3 wherein the transfer tool (17) is or comprises an L-shaped form element (19), wherein the L-shaped form element (19) includes the perpendicularly extending orientation surface (18).

7. The packaging device of claim 6 comprising,
at least one first L-shaped form element (19) which receives and aligns a first unfolded (7), and
at least one second L-shaped form element (19) which receives and aligns a second unfolded packaging (7),
wherein dimensions of the at least one first and second unfolded packaging (7) differ from each other.

8. The packaging device of claim 7 wherein the transfer device (4) comprises at least one insertion aid (25), wherein the at least one insertion aid (25):
holds and/or supports unfolded packaging (7) during insertion of articles (3), and/or wherein the at least one insertion aid (25):
comprises a guide (21), for articles (3) for inserting articles (3) into the unfolded packaging.

9. The packaging device of claim 8 wherein the at least one insertion aid (25) supports the at least one support arm (23).

10. A process for inserting articles (3), such as beverage containers (5) and the like, into unfolded packaging comprising:
receiving and aligning, via at least one transfer device (4), an unfolded packaging (7) to an orientation for receiving at least one article (3) to be insert therein and then transferring the unfolded packaging to a transport device (12) by the at least one transfer device (4), and
inserting at least one article (3) into the unfolded packaging (7), and then transporting, via the transport device (12), the unfolded packaging (7) together with the at least one inserted article (3).

11. The process of claim 10 further comprising forming an unfolded packaging (7) with an erecting device (20) and moving the at least one transfer device (4) and/or a transfer tool (17) back and forth between the transport device and the erecting device in order to receive an unfolded packaging (7) and to transfer the at least one unfolded packaging (7) to the transport device (12).

12. The process of claim 11 wherein the at least one transfer device (4) and/or the transfer tool (17) includes a perpendicularly extending orientation surface (18), and aligning the at least one unfolded packaging (7) on the perpendicularly extending orientation surface (18) to an orientation for receiving at least one article (3) to be inserted therein.

13. The process of claim 12 further comprising:
contacting the unfolded packaging with the perpendicularly extending orientation surface (18) during the receipt via the at least one transfer device (4) and/or
contacting the unfolded packaging (7), during a movement in the direction of the transport device (12), with at least one support arm (23), which places the unfolded packaging (7) into flush contact against the perpendicularly extending orientation surface (18).

14. The process of claim 13 further comprising retaining contact between the at least one support arm (23) and the unfolded packaging (7) during the insertion of articles (3).

15. The process of claim 14 wherein the transfer device (4) comprises at least one insertion aid (25), further comprising:
holding and/or an unfolded packaging (7) with the at least one insertion aid (25) temporally during insertion of the articles; and/or
moving articles (3) through a guide (21) during insertion into an unfolded packaging (7).

16. The process of claim 15 further comprising holding an unfolded packaging means (7) with the at least one insertion aid (25) and then moving the transfer tool (17) away from the transport device (12) so that the unfolded packaging (7) loses its-contact with the transfer tool (17) and is placed on the transport device (12).

17. The process of claim 16 wherein the moving of the transfer tool (17) away from the transport device (12) is started prior to and/or during the insertion of articles (3) into the unfolded packaging.
